(19) United States
(12) Patent Application Publication
(10) Pub. No.: US 2021/0304163 A1
(43) Pub. Date: Sep. 30, 2021

(54) SYSTEM AND METHOD FOR PROCESSING A CRYPTOCURRENCY TRANSACTION USING A SMART TRANSACTION CARD

(71) Applicant: Capital One Services, LLC, McLean, VA (US)

(72) Inventors: Adam VUKICH, Alexandria, VA (US); James ZARAKAS, Centreville, VA (US); Molly JOHNSON, Alexandria, VA (US)

(21) Appl. No.: 16/828,066

(22) Filed: Mar. 24, 2020

(51) Int. Cl. G06Q 20/10; G06Q 20/38; G06Q 20/34

(52) U.S. Cl. CPC G06Q 20/105; G06Q 20/3433; G06Q 20/3829

(57) ABSTRACT

In a method for conducting a transaction using a transaction card, communication between the card's data processor and a transaction terminal is established and the data processor receives from the terminal first transaction information for a financial transaction, the information including a transaction type and a monetary value. The data processor transmits to a user device a cryptocurrency transaction processing request including identification of an amount of cryptocurrency stored in the card's memory that has a value equal to the transaction monetary value. At least a portion of the request is encrypted using private and public encryption keys. The request is configured for retransmission by the user device to a cryptocurrency exchange processor. The card's data processor transmits to the transaction terminal second transaction information usable by the transaction terminal to complete the transaction and updates a cryptocurrency balance stored in the card's memory.

### FIELD OF THE INVENTION

This disclosure relates generally to systems and methods for processing financial transactions involving a transaction card, and more specifically, to a system and method for processing transactions using a transaction card as a cryptocurrency wallet.

### BACKGROUND OF THE INVENTION

Financial transaction cards have become the primary means of carrying out in-person transactions in today's society and the technology associated with and embedded into these cards has increased dramatically. At the same time, there has been a movement toward the use of cryptocurrency for various account transactions. This latter movement, however, has not extended to everyday purchase and transfer transactions such as occur at merchant establishments. As a result, transaction terminals at such establishments (and financial transaction cards used at such terminals) are able to conduct transactions only in ordinary (i.e., non-crypto) currencies. There is, as a result, a desire to enable the use of cryptocurrency at merchant and other establishments where such transaction terminals are used.

### SUMMARY OF THE INVENTION

An illustrative aspect of the invention provides a method for conducting a transaction using a transaction card having a data processor, a card memory, a first communication interface configured for contact or contactless communication with a transaction terminal, and a second communication interface configured for wireless communication with a user device. The method comprises establishing, via the first communication interface, communication between the data processor and a transaction terminal and receiving, by the data processor from the transaction terminal via the first communication interface, first transaction information for a financial transaction. The transaction information includes a transaction type and a transaction monetary value. The method further comprises transmitting, by the data processor to the user device via the second communication interface, a cryptocurrency transaction processing request comprising transaction request information. The request includes identification of a transaction amount of cryptocurrency stored in the card memory. The transaction amount of cryptocurrency has a value that is equal to the transaction monetary value. At least a portion of the request is encrypted using private and public encryption keys stored in the card memory. The request is configured for retransmission by the user device to a cryptocurrency exchange processor. The method still further comprises transmitting, by the data processor to the transaction terminal via the first communication interface, second transaction information including transaction account information for an account associated with the transaction card. The second transaction information is usable by the transaction terminal to complete the transaction. The method also comprises updating, by the data processor, a cryptocurrency balance stored in the card memory.

Another aspect of the invention provides a transaction card comprising a data processor, a first communication interface configured for contact or contactless communication with a transaction terminal, a second communication interface configured for wireless communication with a user device, and a card memory. The card memory has a private card encryption key and a public card encryption key stored therein and a cryptocurrency data block configured for storing cryptocurrency. The card memory also has a cryptocurrency transaction application stored therein. The cryptocurrency transaction application comprises instructions for the data processor to establish, via the first communication interface, communication between the data processor and a transaction terminal. The application further comprises instructions to receive, from the transaction terminal, first transaction information for a financial transaction. The transaction information includes a transaction type and a transaction monetary value. The application still further comprises instructions to retrieve from the cryptocurrency data block a transaction amount of cryptocurrency having a value equal to the transaction monetary value and transmit, to a user device via the second communication interface, a cryptocurrency transaction processing request. The transaction processing request comprises transaction request information and the transaction amount of cryptocurrency. The request is configured for retransmission by the user device to a cryptocurrency exchange processor. The cryptocurrency transaction application also comprises instructions to transmit, to the transaction terminal via the first communication interface, second transaction information including transaction account information for an account associated with the transaction card. The second transaction information is usable by the transaction terminal to complete the transaction.

Another aspect of the invention provides a cryptocurrency transaction processing system comprising a transaction card and a user processing device. The transaction card comprises a terminal communication interface, a card limited range wireless communication interface, a card data processor in communication with the terminal communication interface and the card limited range wireless communication interface, and a card memory accessible by the card data processor. The card memory has stored therein a private card encryption key and a public card encryption key, a cryptocurrency data block having cryptocurrency stored therein, and a cryptocurrency transaction application. The cryptocurrency transaction application comprises instructions for the data processor to establish, via the terminal communication interface, communication between the card data processor and a transaction terminal. The application further comprises instructions to receive, from the transaction terminal, first transaction information for a financial transaction. The transaction information includes a transaction type and a transaction monetary value. The application still further comprises instructions to retrieve from the cryptocurrency data block a transaction amount of cryptocurrency having a value equal to the transaction monetary value and transmit, via the card limited range wireless communication interface, a cryptocurrency transaction processing request comprising transaction request information and the transaction amount of cryptocurrency. The application also comprises instructions to transmit, to the transaction terminal via the terminal communication interface, second transaction information including transaction account information for an account associated with the transaction card. The second transaction information is usable by the transaction terminal to complete the financial transaction. The user processing device has a user interface including a display and a user input device, a user device limited range wireless communication interface, a wireless network communication interface configured for communication with a wireless communication network, a user device data processor in communication with the user device limited range wireless communication interface and the wireless network communication interface, and a user device memory accessible by the user device data processor. The user device memory has a user device transaction application stored therein. The user device transaction application comprises instructions for the user device data processor to receive the cryptocurrency transaction processing request from the card data processor via the user device limited range wireless communication interface, and transmit the cryptocurrency transaction processing request to a cryptocurrency exchange processor via the wireless network communication interface and the wireless communication network.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic representation of a transaction card processing system according to an embodiment of the invention;

FIG. 2 is a schematic representation of a user device usable in embodiments of the invention;

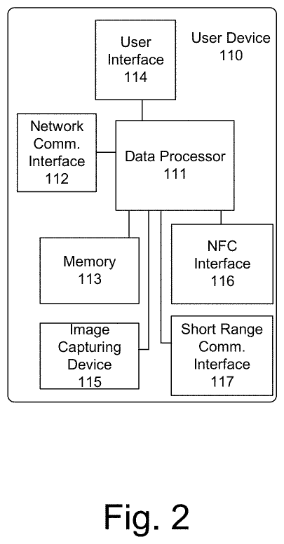

FIG. 3 is a block diagram of a microprocessor chip of a transaction card according to an embodiment of the invention; and

FIG. 4 is a flow chart of actions in a method of conducting a transaction using a smart transaction card according to an embodiment of the invention.

### DETAILED DESCRIPTION OF THE INVENTION

While the invention will be described in connection with particular embodiments and network environments, it will be understood that the invention is not limited to these embodiments and environments. On the contrary, it is contemplated that various alternatives, modifications and equivalents are included within the spirit and scope of the invention as described.

As used herein, the term “transaction card” refers to any identification or payment card associated with a user or user account. This may include, in particular, a credit card, debit card, or gift card, any of which may be issued by a service provider.

As used herein, the term “cryptocurrency” refers to a digital or virtual currency that uses cryptography for security and can be transferred to others or exchanged with others for goods and services. While most cryptocurrencies (e.g., Bitcoin and Ethereum) are tracked and processed using distributed network systems, the term, as used herein, is not limited to such currencies.

The terms “ordinary currency”, “non-cryptocurrency”, and “fiat” or “fiat currency” may be used herein to refer to any government-backed non-digital currency of a country, region, or other globally-recognized governmental entity.

The present invention provides a transaction card capable of functioning as a cryptocurrency wallet from which cryptocurrency can be used for, or converted for use in, carrying out purchase and other transactions in conjunction with conventional flat currency transaction terminals. This may be accomplished by enabling the card to communicate with a transaction terminal (e.g., via direct electrical communication or via near field communication (NFC)) and to communicate with a cryptocurrency exchange processor via the cardholder's mobile device. The cryptocurrency exchange processor may be part of or in communication with a distributed consensus network to maintain transaction information. In some embodiments, a cryptocurrency conversion may be carried out by the card or the exchange processor and a corresponding conventional currency amount placed in an account associated with the transaction card. Payment information relating to this account may be communicated by the transaction card to the transaction terminal for completing the transaction. The use of cryptocurrency and the conversion to a conventional currency may be entirely transparent to the transaction terminal.

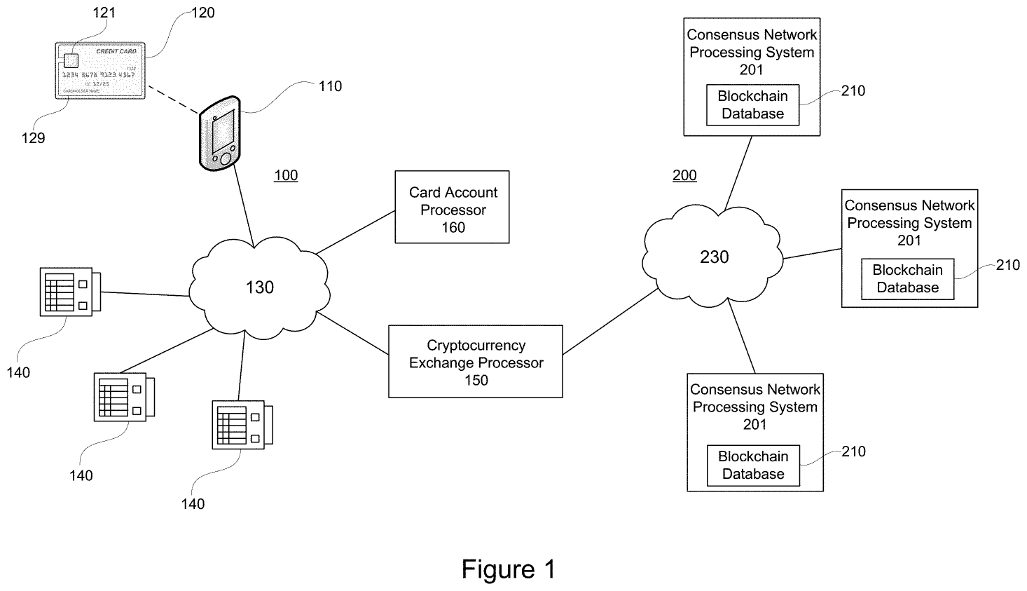

FIG. 1 illustrates a transaction card processing system 100 according to an illustrative embodiment of the invention. The system 100 includes one or more user devices 110, one or more transaction cards 120, a communication network 130, one or more merchant transaction processing devices 140, a cryptocurrency exchange processing system 150, and a card account processing system 160.

In the example embodiments presented herein, an account holder may be any individual or entity that desires to conduct a transaction (which may be, but is not limited to a financial transaction) with a merchant using a transaction account. An account holder user device 110 may be a mobile device or other processor that an account holder uses to carry out a transaction. An account may be held by any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. In some instances, the account holder may be a transaction processing entity such as a financial institution, credit card provider, or other entity that offers accounts to customers. An account may or may not have an associated card, such as, for example, a credit card for a credit account or a debit card for a debit account. The account card may be associated or affiliated with a merchant or one or more social networking sites, such as a co-branded credit card.

As referred to herein, a network-enabled computer system and/or device may include, but is not limited to any computer device, or communications device including, a server, a network appliance, a personal computer (PC), a workstation, and a mobile processing device such as a smart phone, smart pad, handheld PC, or personal digital assistant (PDA). Mobile processing devices may include Near Field Communication (NFC) capabilities, which may allow for communication with other devices by touching them together or bringing them into close proximity. Mobile devices may also include other range-limited communication capabilities such as Bluetooth.

The network-enabled computer systems used to carry out the transactions contemplated in the embodiments may execute one or more software applications to, for example, receive data as input from an entity accessing the network-enabled computer system, process received data, transmit data over a network, and receive data over a network. The one or more network-enabled computer systems may also include one or more software applications to notify an account holder based on transaction information. It will be understood that the depiction in FIG. 1 is an example only, and the functions and processes described herein may be performed by any number of network-enabled computers. It will also be understood that where the illustrated system 100 may have only a single instance of certain components, multiple instances of these components may be used. The system 100 may also include other devices not depicted in FIG. 1.

The network 130 may be any form of communication network capable of enabling communication between the transaction entities and the card processing system 100. For example, the network 130 may be one or more of a wireless network, a wired network or any combination of wireless network and wired network. The network 130 may be or include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal. The network 130 may utilize one or more protocols of one or more network elements to which it is communicatively coupled. The network 130 may translate to or from other protocols to one or more protocols of network devices. Although the network 130 is depicted as a single network, it will be appreciated that it may comprise a plurality of interconnected networks, such as, for example, the Internet, a service provider's network, a cable television network, corporate networks, and home networks.

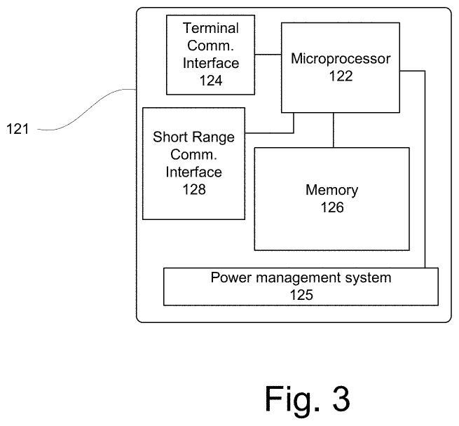

The transaction cards 120 used in methods of the invention may include chip-carrying transaction cards (“smart” cards) having electrical and/or near field or other short range communication capabilities. As illustrated in FIGS. 1 and 3, a typical transaction card 120 that is usable in various embodiments of the invention is a smart card with a microprocessor chip 121. The microprocessor chip 121 includes processing circuitry for storing and processing information, including a microprocessor 122 and a memory 126. It will be understood that the processing circuitry may contain additional components, including processors, memories, error and parity/CRC checkers, data encoders, anticollision algorithms, controllers, command decoders, security primitives and tamper-proofing hardware, as necessary to perform the functions described herein.

The transaction card 120 is configured for communication with transaction terminals and other device via a first communication interface 124. The interface 124 and the microprocessor 122 may, in particular, be configured for establishing communication with merchant transaction processing devices 140 for carrying out purchase and other transactions. The communication interface 124 may be configured to provide for contact-based communication, in which case the interface 124 may have electrical circuitry and contact pads on the surface of the card 120 for establishing direct electrical communication between the microprocessor 122 and the processing circuitry of a transaction terminal 140. Alternatively or in addition, the first communication interface 124 may be configured for contactless communication with the transaction terminals 140. In such embodiments, the communication interface 124 may be or include an NFC communication interface configured for communication with other NFC communication devices when the card 120 is within a predetermined NFC range. The communication interface 124 and the microprocessor 122 may also be configured for establishing NFC communication with the user device 110. In some embodiments, the microprocessor chip 121 may include a second communication interface 128 configured for establishing short range communication with the user device 110 via Bluetooth, or other short range communication methodology. In such embodiments, the transaction card 120 may have a short range communication antenna 129 that is included in or connected to the short range communication interface 128.

In particular embodiments, the transaction card 120 may be Bluetooth enabled using the microprocessor chip 121, the second communication interface 128 and the antenna 129. A Bluetooth-enabled transaction card may support Bluetooth Low Energy (BLE) and may be paired to the user device 110. In some embodiments, pairing and communications may be established between the transaction card 120 and other interfacing devices, such as a terminal (not shown), a merchant transaction processor 140, and the like. A Bluetooth-enabled device may include the capabilities to establish a link between a card and the device (or pair the devices) using device settings (e.g., iOS or Android settings that manage Bluetooth connections) and/or mobile application(s) associated with the card issuer that can cooperate with the device controls to manage a Bluetooth connection with the card 120.

The memory 126 may be a read-only memory, write-once read-multiple memory or read/write memory, e.g., RAM, ROM, and EEPROM, and the chip 121 may include one or more of these memories. The memory 126 may have stored therein information associated with a transaction card account. In some embodiments, the memory 126 may have permanently stored therein a unique alphanumeric identifier associated with the account. It may also have permanently stored public and private card encryption keys. In some embodiments, the private and public encryption keys may be permanently hard-wired into the card memory.

The memory 126 may be configured to store one or more software applications for execution by the microprocessor 122. In various embodiments, the memory 126 may have stored therein instructions for generating encrypted information and transmitting it to a receiving device (e.g., the user device 110) via the first communication interface 124 (e.g., via NFC) or the short-range communication interface 128. Such encrypted information may be or include an encrypted verification block or signature that may be used to authenticate and verify the presence of the transaction card 110 during transaction processing. In embodiments of the invention, the card memory 126 may include an application including instructions configured for operation of the transaction card 120 as a cryptocurrency wallet. In conjunction, the memory 126 may have stored therein information associated with the cryptocurrency wallet, including public and private encryption keys usable for conducting cryptocurrency transactions. The cryptocurrency wallet application may include instructions for storing and maintaining cryptocurrency transaction information in a cryptocurrency data block in the memory 126.

In particular embodiments, the card memory 126 has stored therein a cryptocurrency transaction processing application configured for carrying out a financial transaction at a merchant terminal 140 using the transaction card 120. The application includes instructions for the microprocessor 122 to establish communication with the transaction terminal 140 upon introduction of the transaction card 120 to the transaction terminal 140 (e.g., by insertion of the card 120 for electrical contact, bringing the card 120 within NFC communication range of the transaction terminal 140, or tapping the transaction card 120 to the transaction terminal 140). The application instructions may be configured to cause the microprocessor to receive via the first communication interface 124 information relating to the financial transaction from the transaction terminal 140. Such transaction information may include the type of transaction (e.g., purchase, refund, transfer, account payment, etc.) and a monetary value. The transaction information could also include information about the terminal 140 and/or the entity managing the terminal 140. Such information could include, for example, a terminal or merchant identifier and/or location information.

The cryptocurrency transaction application may include instructions for the microprocessor 122 to determine a currency type in which the transaction is to be conducted. This may be based on the expression of the monetary amount and could include a determination as to whether the transaction is to be conducted in cryptocurrency. If a determination is made that the terminal 140 is capable of conducting the transaction in cryptocurrency, the transaction may move forward solely as a cryptocurrency transfer. If, however, a determination that the terminal 140 is incapable of transacting in cryptocurrency or if the transaction information indicates that the transaction should be conducted in ordinary currency, the application proceeds accordingly. In some embodiments, the application may include, in either case, instructions to transmit to the user device 110 a request to verify that the account holder wishes to use the cryptocurrency wallet to carry out the transaction. This request may include some or all of the transaction information and may be transmitted to the user device 110 via the short range communication interface 128. The application may be further configured to receive a response from the user device 110 indicating whether to use the cryptocurrency wallet or other account transaction functionality to complete the transaction.

Upon a determination that the cryptocurrency wallet is to be used for the transaction, the application may, in some embodiments, cause the microprocessor 122 to retrieve from the cryptocurrency data block a transaction amount of cryptocurrency having a value equal to the transaction monetary value. The microprocessor may then transmit to the user device via the short range communication interface, a cryptocurrency transaction processing request configured for relay by the user device 110 to the cryptocurrency exchange processing system 150. Some or all of this request may be encrypted using public and private keys associated with the cryptocurrency wallet. This may include, for example, hardware and/or software signatures associated with the transaction card 120. The request may include information such as the amount of cryptocurrency to be exchanged and identification information for the transaction card 120 or the transaction card account.

In some embodiments, the transaction card 120 may include a power management system 125, which may include a power source (e.g., a battery, capacitor, photovoltaic cell, kinetic or piezoelectric power scavenger, etc.) and circuitry for managing and distributing power to the components of the chip 121.

The cryptocurrency exchange processing system 150 may be or comprise one or more network-enabled processing systems and may, in some embodiments, be configured to be part of or in communication with a distributed consensus network 200. The cryptocurrency exchange processing system 150 is configured to facilitate the exchange of cryptocurrency. In particular, the cryptocurrency exchange processing system 150 may be configured to conduct an exchange transaction to exchange amount of cryptocurrency in the request for a corresponding amount of ordinary fiat currency. Upon completion of the exchange, the cryptocurrency exchange processing system 150 may process a transaction to deposit the fiat currency into the account associated with the transaction card. As part of this transaction, the cryptocurrency exchange processing system 150 may communicate with the card account processor 160 via the network 130 or other network. In some embodiments, the cryptocurrency exchange processor 150 may, upon completion of the cryptocurrency exchange or upon completion of the deposit transaction, transmit a completion notification to the user device 110. This notification may be configured for display to the user by the user device 110. In addition or instead, the completion notification may be configured to be retransmitted by the user device 110 to the transaction card 120. In some embodiments, the completion notification may be or include information encrypted using the public and private keys associated with the transaction card wallet. Notification information may include information to be stored in the cryptocurrency data block of the memory 126.

In some embodiments, the processing system 150 may be provided with the public and private encryption keys associated with the transaction card cryptocurrency wallet and may be configured to decrypt encrypted transaction information and/or card-specific signatures.

The cryptocurrency exchange processing system 150 may be configured to initiate and/or add to a blockchain associated with the transaction card cryptocurrency wallet. The blockchain may be tracked in a blockchain database 210 maintained in the system nodes 201 of the consensus network. This may be accomplished by the cryptocurrency exchange processing system 150 by transmitting some or all of the encrypted transaction information (which may incorporate unique hardware and software signatures associated with the transaction card 120) to one or more of computing system nodes 201. The cryptocurrency exchange processing system 150 may be configured to communicate with the processing system nodes 201 of the consensus computing network 200 via a consensus system communication network 230.

Returning now to the cryptocurrency transaction application, the application may further include instructions for the microprocessor 122 to transmit to the transaction terminal 140 via the first communication interface 124 information required by the terminal 140 to complete the transaction. This information may include identification of the transaction account associated with the transaction card. In some embodiments, transmission of the transaction completion information may be withheld until the microprocessor 122 has received the completion notification relayed to the transaction card 120 by the user device 110. In other embodiments, however, the transaction completion information may be transmitted without the completion notification having been received. In some embodiments, the transaction completion information may be transmitted immediately upon determination that the cryptocurrency wallet is to be used for the transaction.

In embodiments of the invention, the cryptocurrency wallet application or the cryptocurrency transaction application may include instructions to update wallet information in the card memory 126. This may include, for example, updating a balance of cryptocurrency in the wallet.

The user device 110 may be any computer device or communications device including a server, a network appliance, a personal computer (PC), a workstation, and a mobile interface device such as a smart phone, smart pad, handheld PC, or personal digital assistant (PDA). The user device 110 includes an on-board data processor 111 in communication with a memory module 113, a user interface 114, a network communication interface 112, an NFC interface 116, and a short-range wireless communication interface 117. The user device 110 may optionally include an image capturing device 115 (e.g., a digital camera). The data processor 111 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The memory 113 can be a read-only memory, write-once read-multiple memory or read/write memory, e.g., RAM, ROM and EEPROM, and the user device 110 can include one or more of these memories.

The user interface 114 of the device 110 includes a user input mechanism, which can be any device for entering information and instructions into the user device 110, such as a touch-screen, keyboard, mouse, cursor-control device, microphone, stylus, or digital camera. The user interface 114 may also include a display, which can be any type of device for presenting visual information such as a computer monitor, a flat panel display, and a mobile device screen, including liquid crystal displays, light-emitting diode displays, plasma panels, and cathode ray tube displays.

The network communication interface 112 is configured to establish and support wired or wireless data communication capability for connecting the device 110 to the network 130 or other communication network. The NFC interface 116 is configured for establishing near field communication with other NFC-enabled devices. In some embodiments, the NFC interface 116 may be used to establish communication with a merchant transaction terminal 140 or the data processing chip 121 on board the transaction card 120. The short range communication interface 117 is configured for establishing communication with other devices via Bluetooth, or other short range communication methodology and may incorporate an on-board antenna for use in transmission and reception. The short range communication interface 117 may, in particular, be configured for receiving information transmitted by the data processing chip 121 of the transaction card via the card's short range communication interface 124. In embodiments where the transaction card 120 is a Bluetooth enabled device, the card 120 may be paired to the user device 110.

In embodiments of the invention, the memory 113 may have stored therein one or more applications usable by the data processor 111 to conduct and/or monitor transactions and communications between the user device 110, the transaction card 120, the merchant transaction processing devices 140, the cryptocurrency exchange processor 150, and the card account processor 160 over the network 130. These applications may include instructions usable by the data processor 111 to identify transaction events, store event data in the memory 113, and communicate event data to various systems. Some applications may also include instructions relating to receiving and interpreting instructions from other systems.

In various embodiments, the memory 113 may include a transaction card account application configured for facilitating transactions using the transaction card 120. This application may include instructions for transmitting and receiving account information to and from the card account processor 160. The application may further include instructions for displaying information to the account holder/user and receiving input or instructions from the account holder/user. The transaction application may include instructions for communicating directly with a merchant terminal 140 or the card account processor 160 for conducting transactions.

In particular embodiments, the user device transaction applications may include instructions for facilitating a cryptocurrency transaction initiated by the transaction card 120. This may include instructions for the data processor 111 to receive from the card microprocessor 122 via the short-range communication interface 117 a cryptocurrency transaction processing request. The data processor 11 may then be instructed to retransmit the request to the cryptocurrency exchange processor 150 via the network communication interface 112 and the network 130. In some embodiments, the application may be configured to include information about the user device 110 and/or the account holder with the retransmitted cryptocurrency transaction processing request. The application may further include instructions to receive a cryptocurrency transaction completion notification from the cryptocurrency exchange processor 150 via the network communication interface 112 and the network 130. In certain embodiments, information from the transaction completion notification may be displayed to the user via the user interface 114. The application may further be configured to instruct the data processor 111 to transmit some or all of the transaction completion notification to the transaction card 120 via the short range communication interface 116.

In some embodiments, the transaction card account application may include instructions to receive from the transaction card 120 via the short range communication interface 117 a request to verify that the account holder wishes to use the cryptocurrency wallet to carry out a transaction. Further instructions may cause the data processor 111 to display some or all of the verification request to the account holder/user via the user interface 114 and to receive response information from the account holder/user via the user interface 114. This could include an indication that the user wants to proceed with the transaction using the cryptocurrency wallet, that the user wants to proceed with the transaction using another transaction processing mode, or that the user does not wish to proceed with the transaction. The application may be further configured to use the response information to construct a verification response and to transmit the response to the transaction card via the short range communication interface 117.

The merchant transaction processing devices 140 may be any network enabled processors configured for processing a transaction involving the transaction card 120. As used herein, a merchant is any entity with which an account holder carries out a transaction. This may include without limitation any retailer, wholesaler, or bartering entity. A merchant may have one or more physical locations or may be an online retailer. The merchant transaction processing device 140 may be any network enabled device (e.g., cash register or other POS terminal or an on-line transaction server) that is capable of communicating with the transaction card 140 (e.g., by contact-based electrical communication or by NFC communication) or otherwise receiving transaction card information for carrying out a transaction and is capable of communicating with the card account processor 160 via the network 130.

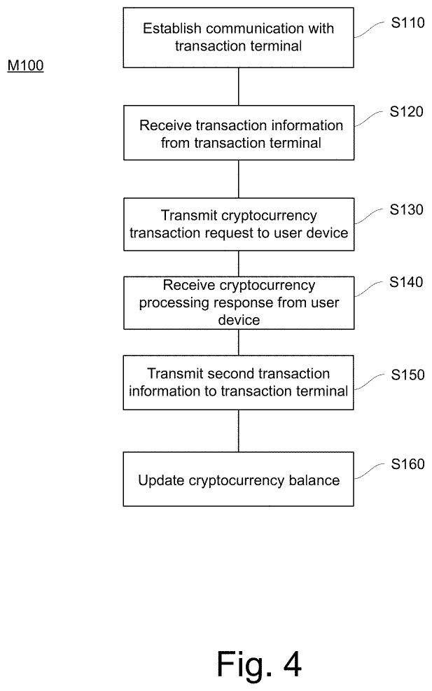

Aspects of the transaction card processing system 100 and, in particular, the transaction card 120, can be used to carry out any of various methods of processing cryptocurrency transactions according to embodiments of the invention. FIG. 4 illustrates a basic method M100 of conducting a transaction using a smart transaction card having a card data processor, a card memory, a first communication interface configured for contact or contactless communication with a merchant processing device/terminal, and a second communication interface configured for wired or wireless communication with any of various user devices. The transaction itself may be any transaction associated with a financial account associated with the transaction card, but will typically be a purchase, payment, or other monetary transfer transaction.

At S110 of the method M100, communication is established between the data processor of the transaction card and a transaction terminal for the purpose of conducting or completing a financial transaction. Depending on the type of card, such communication will typically be initiated by inserting the card into a slot in the transaction terminal (thereby establishing communication via contacts on the card surface) or by tapping the transaction card to the transaction terminal or otherwise bringing the transaction card within NFC range of the transaction terminal. Upon establishing communication, the card data processor receives transaction information from the transaction terminal via the card's terminal communication interface at S120. The transaction information may include information about the financial transaction including the amount to be transferred. The information may also include information about the transaction terminal such as its location and managing entity. In particular embodiments, the information may include one or both of a terminal identifier and a merchant identifier. In some embodiments, the transaction information may specify a currency type (e.g., cryptocurrency or a particular fiat currency).

At S130, the card data processor uses the transaction information to construct and transmit a cryptocurrency transaction request to a user device of the card account holder. This user device may be any device of the account holder that has been previously associated with the transaction card. Typically, the user device will be a mobile device such as a smart phone, tablet computer, smart wearable device, portable laptop computer, or voice command device. In typical embodiments, the card data processor will transmit the request via a second card communication interface. This second interface may be configured for short range wireless transmission (e.g., via Bluetooth technology). The request may include some or all of the transaction information received from the transaction terminal. In some embodiments, the request may include specification of cryptocurrency information retrieved from the transaction card's memory and may request that the specified cryptocurrency be converted for use in completing the transaction. In typical embodiments, the value of the specified cryptocurrency in fiat currency is greater than or equal to the transaction amount. The cryptocurrency transaction request may be constructed for relay by the user device to a cryptocurrency exchange processor. This may mean that some or all of the information in the request is encrypted using at least a private encryption key that is not available to the user device, but is available for decryption by the cryptocurrency exchange processor. Accordingly, in some embodiments, at least a portion of the request is encrypted using private and public encryption keys stored in the card memory.

The cryptocurrency transaction request provides a sufficient information for the cryptocurrency exchange processor to exchange the specified cryptocurrency for a corresponding amount of fiat currency and to conduct a deposit transaction to deposit the amount into the transaction card account. The request may also include sufficient information and, in some embodiments, appropriately encrypted signatures or other information for the exchange processor to communicate the transaction to a distributed consensus network.

In some embodiments, the action S130 may be conditioned on receiving verification from the account holder/user that the cryptocurrency wallet functionality of the transaction card is to be used for the transaction. In such embodiments, the method M100 may include the action of transmitting a verification request to the user device. This request may include some or all of the transaction information and may be transmitted to the user device via the second communication interface. The user device may display some or all of this information to the account holder/user and request instructions from the account holder/user. The user may respond that the cryptocurrency functionality is to be used, whereupon the user device transmits a positive verification response to the transaction card. The method M100 may also include the action of receiving, by the transaction card from the user device, the response indicating that the cryptocurrency wallet functionality is to be used to complete the transaction. Any contrary response may be result in termination of the transaction or use of an alternative currency payment approach.

At S140, the transaction card receives a cryptocurrency processing response. This may be in the form of a transaction completion notification. The response may be received from the cryptocurrency exchange processor via the user device. As previously discussed, the user device may receive the response/completion notification from the exchange processor via a broad network connection and then retransmit some or all of it to the transaction card via the short range communication interface. In some embodiments, the response/completion notification may be or include information encrypted using the public and private keys associated with the transaction card wallet Notification information may include information to be stored in the cryptocurrency data block of the memory.

At S150, the transaction card transmits a second set of transaction information to the transaction terminal via the terminal communication interface. This transaction information may include identification of the transaction account associated with the transaction card and/or other information required by the transaction terminal for completion of the transaction. In some embodiments, the action at S150 may be withheld until after reception of a completion notification as part of the action at S140. In other embodiments, however, the action at S150 may be taken at any time after the action at S120. In some embodiments, however, the action at S150 may be conditioned on receiving a positive user response to a transaction verification request.

At S160, the transaction card microprocessor may update cryptocurrency information stored in the card's memory. This may include, in particular, updating the balance of cryptocurrency in the card memory.

The methods and systems of the present invention provide a significant improvement to the use of transaction cards for cryptocurrency transactions by using the card itself as a cryptocurrency wallet. The card is usable at merchant terminals that do not support or are not configured to use cryptocurrency. Because the card is capable of communicating with both the merchant transaction terminal and, via the cardholder's mobile device, a cryptocurrency exchange, the card can exchange cryptocurrency for use in the transaction in a manner that is completely transparent to the merchant terminal.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

1. A method for conducting a transaction using a transaction card having a card data processor, a card memory having a unique identifier and private and public encryption keys permanently hard-wired therein and being capable of receiving and storing cryptocurrency therein, a first communication interface configured for near field communication (NFC) with a transaction terminal, and a second communication interface configured for wireless communication with a user device, the method comprising:
placing the transaction card within NFC range of the transaction terminal, the card memory of the transaction card having cryptocurrency stored therein;
establishing, via the first communication interface, NFC communication between the card data processor and the transaction terminal;
receiving, by the card data processor from the transaction terminal via the first communication interface, a first NFC communication comprising first transaction information for a financial transaction, the transaction information including a transaction type and a transaction monetary value;
constructing, by the card data processor, a cryptocurrency transaction processing request comprising transaction request information, said request including identification of a transaction amount of cryptocurrency that is less than or equal to a balance of the cryptocurrency stored in the card memory, the transaction amount of cryptocurrency having a value that is equal to the transaction monetary value, said request being configured for retransmission by the user device to a cryptocurrency exchange processor;
encrypting, by the card data processor, at least a portion of said cryptocurrency transaction processing request using the private and public encryption keys;
transmitting the cryptocurrency transaction processing request by the card data processor to the user device via the second communication interface;
transmitting, by the card data processor to the transaction terminal via the first communication interface, a second NFC communication comprising second transaction information including transaction account information for an account associated with the transaction card, the second transaction information being usable by the transaction terminal to complete the transaction; and
updating, by the card data processor, the balance of cryptocurrency stored in the card memory.

2. A method according to claim 1 further comprising:
receiving, by the card data processor from the user device via the second communication interface, a cryptocurrency processing response generated by the cryptocurrency exchange processor, at least a portion of said response being encrypted using the private and public encryption keys.

3. A method according to claim 2 wherein the cryptocurrency processing response includes at least a portion of the transaction account information and the cryptocurrency processing response is received before the action of transmitting second transaction information.

4. A method according to claim 1 further comprising:
transmitting, by the card data processor to the user device via the second communication interface, a cryptocurrency transaction verification request comprising at least a portion of the transaction request information; and
receiving, by the card data processor from the user device via the second communication interface, a verification response.

5. A method according to claim 4 wherein the actions of transmitting a cryptocurrency transaction processing request, transmitting second transaction information, and updating a cryptocurrency balance stored in the card memory are carried out only upon receiving a positive verification response.

6. A method according to claim 1 wherein the transaction terminal is a merchant terminal and the transaction type is a purchase and the action of updating includes subtracting the transaction amount of cryptocurrency from the cryptocurrency balance.

7. A method according to claim 1 wherein
the transaction monetary value is expressed in a non-cryptocurrency denomination, and
the cryptocurrency transaction processing request includes a request to exchange the transaction amount of cryptocurrency for an equivalent amount of the non-cryptocurrency denomination and to deposit said equivalent amount in the account associated with the transaction card.

8. (canceled)

9. A transaction card comprising:
a card body; and
a microprocessor chip attached to the card body, the microprocessor chip comprising
a data processor,
a first communication interface configured for near field communication (NFC) with a transaction terminal,
a second communication interface configured for wireless communication with a user device, and
a card memory having
a private card encryption key and a public card encryption key permanently hard-wired therein,
a cryptocurrency data block configured for storing cryptocurrency,
a cryptocurrency transaction application stored therein, the cryptocurrency transaction application comprising instructions for the data processor to
establish, via the first communication interface, NFC communication between the data processor and a transaction terminal,
receive, from the transaction terminal, a first NFC communication comprising first transaction information for a financial transaction, the first transaction information including a transaction type and a transaction monetary value,
retrieve from the cryptocurrency data block a transaction amount of cryptocurrency stored therein, the transaction amount having a value equal to the transaction monetary value,
construct a cryptocurrency transaction processing request comprising transaction request information and the transaction amount of cryptocurrency, said request being configured for retransmission by the user device to a cryptocurrency exchange processor,
encrypt at least a portion of the cryptocurrency transaction processing request using the private and public card encryption keys,
transmit, to the user device via the second communication interface, the cryptocurrency transaction processing request, and
transmit, to the transaction terminal via the first communication interface, a second NFC communication comprising second transaction information including transaction account information for an account associated with the transaction card, the second transaction information being usable by the transaction terminal to complete the transaction.

10. (canceled)

11. A transaction card according to claim 9 wherein the cryptocurrency transaction application further comprises instructions for the data processor to receive from the user device via the second communication interface, a cryptocurrency processing response generated by the cryptocurrency exchange processor, at least a portion of said response being encrypted using the private and public card encryption keys.

12. A transaction card according to claim 11 wherein
the cryptocurrency transaction application further comprises instructions for the data processor to decrypt the cryptocurrency processing response using the private and public card encryption keys,
the cryptocurrency processing response includes at least a portion of the transaction account information, and
the cryptocurrency processing response is received before the action of transmitting second transaction information.

13. A transaction card according to claim 12 wherein the cryptocurrency transaction application further comprises instructions for the data processor to
transmit, to the user device via the second communication interface, a cryptocurrency transaction verification request comprising at least a portion of the transaction request information, and
receive, from the user device via the second communication interface, a verification response.

14. A transaction card according to claim 13 wherein the cryptocurrency transaction application is configured to cause the data processor to carry out the actions to transmit a cryptocurrency transaction processing request and transmit second transaction information only upon receiving a positive verification response.

15. A transaction card according to claim 9 wherein the cryptocurrency transaction application further comprises instructions for the data processor to
determine whether the transaction monetary value is expressed in a non-cryptocurrency denomination, and
responsive to a determination that the transaction monetary value is expressed in a non-cryptocurrency denomination, include in the cryptocurrency transaction processing request a request to exchange the transaction amount of cryptocurrency for an equivalent amount of the non-cryptocurrency denomination and to deposit said equivalent amount in the account associated with the transaction card.

16. A cryptocurrency transaction processing system comprising
a transaction card comprising
a card near field communication (NFC) interface,
a card limited range wireless communication interface,
a card data processor in communication with the terminal communication interface and the card limited range wireless communication interface, and
a card memory accessible by the card data processor and having stored therein
a private card encryption key and a public card encryption key, said keys being permanently hard-wired into the card memory,
a cryptocurrency data block configured for storing cryptocurrency therein,
a cryptocurrency transaction application comprising instructions for the data processor to
establish, via the terminal communication interface, NFC communication between the card data processor and a transaction terminal,
receive, from the transaction terminal, a first NFC communication comprising first transaction information for a financial transaction, the first transaction information including a transaction type and a transaction monetary value,
retrieve from the cryptocurrency data block a transaction amount of cryptocurrency stored therein, the transaction amount having a value equal to the transaction monetary value,
construct a cryptocurrency transaction processing request comprising transaction request information and the transaction amount of cryptocurrency,
encrypt at least a portion of the cryptocurrency transaction processing request using the private and public card encryption keys,
transmit, via the card limited range wireless communication interface, the cryptocurrency transaction processing request, and
transmit, to the transaction terminal via the terminal communication interface, a second NFC communication comprising second transaction information including transaction account information for an account associated with the transaction card, the second transaction information being usable by the transaction terminal to complete the financial transaction; and
a user processing device having
a user interface including a display and a user input device,
a user device limited range wireless communication interface,
a wireless network communication interface configured for communication with a wireless communication network,
a user device data processor in communication with the user device limited range wireless communication interface and the wireless network communication interface,
and a user device memory accessible by the user device data processor and having a user device transaction application stored therein, the user device transaction application comprising instructions for the user device data processor to
receive the cryptocurrency transaction processing request from the card data processor via the user device limited range wireless communication interface, and
transmit the cryptocurrency transaction processing request to a cryptocurrency exchange processor via the wireless network communication interface and the wireless communication network.

17. A cryptocurrency transaction processing system according to claim 16 wherein
the user device transaction application further comprises instructions for the user device data processor to
receive a cryptocurrency processing response from the cryptocurrency exchange processor via the wireless network communication interface and the wireless communication network, and
transmit the cryptocurrency processing response to the card data processor via the user device limited range wireless communication interface, and
the cryptocurrency transaction application further comprises instructions for the card data processor to
receive the cryptocurrency processing response from the user device via the card limited range wireless communication interface.

18. A cryptocurrency transaction processing system according to claim 16 wherein
the cryptocurrency transaction application further comprises instructions for the card data processor to
transmit, to the user device via the card limited range wireless communication interface, a cryptocurrency transaction verification request comprising at least a portion of the transaction request information,
receive, from the user device via the second wireless communication interface, a verification response, and
carry out the actions to retrieve a transaction amount of cryptocurrency, transmit a cryptocurrency transaction processing request, and transmit second transaction information only upon receiving a positive response verification, and
the user device transaction application further comprises instructions for the user device data processor to
receive the cryptocurrency transaction verification request from the card data processor via the user device limited range wireless communication interface,
determine the verification response for the financial transaction, and
transmit the verification response to the card data processor via the user device limited range wireless communication interface.

19. A cryptocurrency transaction processing system according to claim 18 wherein the action to determine the verification response includes displaying the at least a portion of the transaction request information to a user via the display and receiving verification response input from the user via the user input device.

20. A cryptocurrency transaction processing system according to claim 16 wherein the cryptocurrency transaction application further comprises instructions for the data processor to
determine whether the transaction monetary value is expressed in a non-cryptocurrency denomination, and
responsive to a determination that the transaction monetary value is expressed in a non-cryptocurrency denomination, include in the cryptocurrency transaction processing request a request to exchange the transaction amount of cryptocurrency for an equivalent amount of the non-cryptocurrency denomination and to deposit said equivalent amount in the account associated with the transaction card.
